(19) United States
(12) Patent Application Publication
(10) Pub. No.: US 2026/0309437 A1
(43) Pub. Date: Oct. 8, 2026

(54) BREECH BLOCK FOR A CANNON AND METHOD FOR THE MANUFACTURING OF A BREECH BLOCK FOR A CANNON

(71) Applicant: BAE SYSTEMS BOFORS AB, Karlskoga (SE)

(72) Inventors: Martin Perkovic, Karlskoga (SE); Emil Perkovic, Karlskoga (SE); Fredrik Thuvander, Karlskoga (SE)

(21) Appl. No.: 19/481,289

(22) PCT Filed: Apr. 12, 2024
(86) PCT No.: PCT/SE2024/050347

§ 371 Date: Nov. 4, 2025

(30) Foreign Application Priority Data
May 9, 2023 (SE) 2300041-7

(51) Int. Cl. F41A 3/00; B22F 10/28; B22F 10/64; B22F 10/66; B33Y 10/00; B33Y 40/20; B33Y 70/00; B33Y 80/00

(52) U.S. Cl. CPC F41A 3/00; B22F 10/28; B22F 10/64; B22F 10/66; B22F 2301/35; B33Y 10/00; B33Y 40/20; B33Y 70/00; B33Y 80/00

(57) ABSTRACT

The present invention relates to a method for the production of a breech block for a cannon where the method comprises that a raw material for a breech block is manufactured additively from at least one metal powder. Once a raw material for a breech block has been manufactured, the raw material for the production of a breech block is post-treated by exposing the raw material to high pressure and heat also called Hot Isostatic Pressing, HIP, for pressing and sintering the metal powders included in the raw material. The invention further relates to a breech block and a cannon comprising a breech block.

### CROSS-REFERENCE TO RELATED APPLICATIONS

The present application is a National Stage entry of PCT Application No. PCT/SE2024/050347, entitled “BREECH BLOCK FOR A CANNON AND METHOD FOR THE MANUFACTURING OF A BREECH BLOCK FOR A CANNON”, filed Apr. 12, 2024, which claims priority to SE Application No. SE2300041-7, entitled “BREECH BLOCK FOR A CANNON AND METHOD FOR THE MANUFACTURING OF A BREECH BLOCK FOR A CANNON”, filed May 9, 2023, the disclosures of which are incorporated by reference herein in their entireties.

### TECHNICAL FIELD

The present invention relates to a method for the production of a breech block for a cannon where the method comprises that a raw material for a breech block is manufactured additively from at least one metal powder. Once a raw material for a breech block has been manufactured, the raw material for the production of a breech block is post-treated by exposing the raw material for a breech block to high pressure and heat also called Hot Isostatic Pressing, HIP, for pressing and sintering the metal powders included in the raw material. The invention further relates to a breech block and a cannon comprising a breech block.

### BACKGROUND

Launchers, such as barrel-based weapons, are fired by burning gunpowder and thereby creating a gas expansion, where the gas expansion moves a projectile in a barrel. The breech block mechanism is a common mechanism for launchers such as a cannons, especially automatic cannons. A central component of the breech block mechanism is a nearly rectangular block of metal, also called a wedge, which can slide inside a groove in the cannon, with the rear part of the piece being perpendicular to the longitudinal axis of the barrel. By operating the breech block perpendicularly to the barrel, an opening to the chamber of the barrel can be created so that an ammunition unit can be arranged in the chamber, after which the breech block can be maneuvered so that it is arranged behind the ammunition unit and thereby locks the ammunition unit inside the barrel, after which the ammunition unit can be fired. Preferably, a firing pin is arranged in the breech block which can strike an igniter arranged in the ammunition unit which initiates the propellant charge in the ammunition unit. The breech block design allows for a high rate of fire, but it is not gas-tight, which means that the propellant charge must be enclosed in a casing. When the piece is to be loaded, the breech block is moved to the side, this movement being powered by hand or machine, and an ammunition unit is inserted into the chamber. In a common embodiment, the casing of the ammunition unit hits ejectors which are arranged on both sides of the cartridge position/chamber, and this releases a latch which closes the breech block. Once the ammunition unit is fired, the breech block mechanism is opened once again, usually by means of the recoil force. The mechanism is designed so that the breech block pushes the ejectors backwards as it slides away so that the empty casing is ejected. Then the process can be initiated again so that an autocannon can be provided, which repeatedly, in succession, fires ammunition units. Each ammunition unit is arranged with a projectile and propellant arranged in a casing. An ignition device is arranged inside the casing, often including an ignition cap that is able to ignite the propellant charge. As an alternative to an ignition cap, the propellant charge can be ignited by means of, for example, an electrical pulse or a laser.

Examples of manufacturing methods for breech blocks or other bolt components are given in patent document CN 110893503 A, which describes a method for manufacturing components through an additive manufacturing method including arc welding.

Examples of manufacturing methods including hot isostatic pressing are given in patent document US 2020/0230699 A1, which describes a method for manufacturing hollow components with hot isostatic pressing.

The above prior art does not demonstrate that additive manufacturing methods including powders for the manufacture of breech blocks are useful.

Additional problems which the present invention seeks to solve will become apparent in connection with the following detailed description of the various embodiments.

### SUMMARY OF THE INVENTION

The purpose of the present invention is to achieve an improved way of manufacturing a breech block additively with high tolerance (near net shape) adapted to operate in harmony with other metal components included in the cannon.

The invention relates to a method for the production of a breech block for a launch device where the method includes that a raw material for a breech block is manufactured additively from two different metal powders, a surface material and a bulk material, after a raw material for a breech block has been manufactured, the raw material for the production of a breech block is post-processed by exposing the raw material for a breech block for high pressure and heat, also called Hot Isostatic Pressing, HIP, for pressing and sintering the metal powders included in the raw material.

According to further aspects for the method of manufacturing a breech block according to the invention apply;
that additive manufacture comprises the metal powder being melted in a vacuum chamber by an electron beam.
that additive manufacture comprises the metal powder being distributed over a surface and melted by a laser beam.
that post-treatment further, following hot isostatic pressing, includes heat treatment.
that post-treatment further, following hot isostatic pressing and heat treatment, includes mechanical processing of the breech block.
that the surface material preferably consists of low alloy NiCrMo steel.

A low-alloy NiCrMo steel is characterized by high degrees of resilience and hardness. The aforementioned high degree of hardness is required due to abrasion occurring during firing and aforementioned high resilience is quired for purposes of resisting plastic deformation. Due to the surface layer having such a high degree of resilience, properties such as ductility and toughness will be affected. Rather, the material will be somewhat brittle. For this reason, a tough core is required, as in the bulk material, made up of steel with more alloy, e.g. tool steel or martensitic stainless steel.

The low-alloy NiCrMo steel has a yield point of at least 1200 MPa and a yield point at −40 C of at least 27 J.
that the bulk material is preferably made up of stainless steel or tool steel.

The stainless steel or tool steel has higher levels of Cr and Ni than the low-alloy carbon steel used for the surface. The core, the bulk material, must consist of a steel with lower alloy content, e.g. a tool steel with higher levels of Cr and Ni than the low-alloy carbon steel used for the surface. A risk inherent in HIP is that every grain in the metal prior to HIP might oxidize and then lead to properties of toughness and fatigue being decreased, as the oxides of each grain lead to natural crack growth paths. Thus, steels (stainless steels/tool steels) with higher levels of Chromium are used, as they form chromium oxide and counteract this. The core material must be stainless or a tool steel and characterized by properties such as good fatigue resistance, toughness, and ductility. The materials used could be, for example:

Stainless martensitic steels; X4CrNiMo16-5-1 (1.4418), Super 13 Cr (UNS S41426) Tool steel: X40CrMoV5-1

The stainless steel or tool steel has a yield strength of approximately 800-900 MPa and an impact toughness at −40 °C of a minimum of 50 J.

The invention further consists of a breech block adapted to cooperate with other metal components included in the cannon.

The invention further consists of a cannon comprising a breech block.

By manufacturing parts of the breech block or the entire breech block through additive manufacturing, one can achieve a breech block with higher strength and toughness compared to currently existing technology that is based on processing of a forging blank by means of cutting. For future firing systems, where both the rate of fire and the forces acting on the breech block are expected to increase, new manufacturing solutions for the breech block are required to improve the breech block's properties.

### BRIEF DESCRIPTION OF THE DRAWINGS

The invention will be described below by reference to the figures that are included there:

FIG. 1 shows a cross-section of a breech block according to one embodiment of the invention.

FIG. 2 shows the method steps for the manufacture of a breech block, according to one embodiment of the invention.

### DETAILED DESCRIPTION OF THE DRAWINGS

The present invention shows embodiments of manufacturing methods for improved breech block for cannon.

A firing device, also termed a cannon, a howitzer, or an artillery piece, in the sense of an autocannon, has the goal of making use of a propellant for the purpose of firing a projectile. Preferably, a propellant, such as gunpowder, is initiated in one part of the cannon, oftentimes a chamber specifically adapted to the purpose. For the automatic cannon, the propellant is preferably arranged in a casing. Initiation takes place by way of igniting the propellant, for instance by means of an ignition cartridge or an igniter in a munition device, which is initiated by means of striking. Other methods for igniting the propellant may include ignition of the propellant by means of laser energy or electric energy. The propellant burns at a high rate and results in large amounts of gas being produced, which creates a gas pressure in the chamber which propels the projectile out of the barrel of the cannon. The propellant has been adapted in order to generate a constant pressure on the projectile during the entire barrel procedure, to the greatest extent possible, as the projectile moves in the barrel, which results in the projectile leaving the muzzle of the barrel with high speed. For automatic guns arranged to fire ammunition units, the projectile, igniter, and the propellant are arranged in a casing. Since the propellant is arranged in a casing, a simpler mechanism, often called a breech block, can be used to seal behind the ammunition unit when the ammunition unit is arranged in the chamber of the barrel. The breech block does not have a gas-tight seal against the barrel, which enables a high rate of fire, i.e. ammunition units can be exchanged at high speed by opening the breech block and enabling an ammunition unit to be fitted in the barrel and then moving the breech block so that it closes to the barrel, after which the projectile is fired from the ammunition unit, and the empty casing is subsequently removed to once again arrange an ammunition unit in the barrel.

If breech blocks, or other parts for firing systems, are manufactured with HIP, materials with high resistance to impact loads can be produced. Impact loads are part of the recoil forces that arise in a launch system when projectiles are fired from a barrel. The goal is to provide a breech block with higher strength and toughness compared to currently existing technology. Since the breech block is part of the mechanism in a firing system, compatibility between materials used in the various components included in the firing system is assumed. If, for example, the breech block is changed to a different material than other components in the launch system, there is a risk that corrosion may occur, e.g. if the degree of nobility varies between the components included in the launch system. In particular, there are risks of corrosion when it comes to pieces in a marine environment, since a conductive liquid, such as salt water, can act as a conductive liquid that can cause galvanic corrosion of the components included in the piece if the material/nobility across the components differs. Thus, it is relevant for the surface of the improved breech block has similar material properties as surrounding components in the launch system, since the breech block will be close to other components in the launch system and will also be exposed to salt water.

Through additive manufacturing of a breech block where the additively manufactured breech block undergoes hot isostatic pressing, an improved breech block can be produced. Preferably, a breech block is created additively with a specific material, but can also be made from two materials, a material in the core and a material in the surface layer. The additively manufactured component undergoes Hot Isostatic Tarpaulin to eliminate pores in the detail.

The raw material for the breech block is manufactured additively, preferably by means of 3D Printing, as the outer geometry of the breech block is too complex to manufacture as is usually done with HIP, i.e. pressing of sheet metal and welding. Additive manufacturing of the breech block means that a breech block with great precision can be manufactured, which means that subsequent processing can be avoided or reduced. The procedure is called manufacturing according to Near Net Shape, NNS. Once the raw material for the breech block has been manufactured additively, the HIP process is started with evacuation and vibration. This is followed by HIP in oven.

Hot isostatic pressing, HIP (Hot Isostatic Pressing), is a production process to control the grain size and structure of the material. HIP also allows metal powder, polymer powder, ceramic powder and composite powder to be pressed into a solid form. The advantages include the fact that all the empty spaces inside metal components that are created through additional manufacturing methods are removed and that mechanical properties such as fatigue resistance/fatigue strength, toughness, plasticity and impact resistance are improved. Furthermore, HIP can create a dense material from metal powder, composite powder, polymer powder or ceramic powder without melting, and materials with partially different characteristics can be combined in the same component.

Using HIP, a solid material can be created from powder with superior properties because the powder/powder components have a fine, uniform grain size and an isotropic structure. Furthermore, with HIP, different metals can be joined together without needing a temperature-limiting adhesive. Using HIP, several diffusion bonds can be achieved in one process cycle. HIP works for a large number of metal alloys, such as polymers and ceramic material. For example, alloys with nickel, cobalt, tungsten, titanium, molybdenum, aluminum, copper and iron, oxide- and nitride ceramics, glass, intermetallic substances and polymers. HIP enables the bonding and combining of materials that otherwise cannot be combined, i.e. composites.

Once the raw material for the breech block has undergone hot isostatic pressing, various forms of heat treatment can be carried out to change the mechanical properties of the breech block. Following heat treatment, fine processing can be carried out such as cutting processing or grinding of the part to adapt the part based on adaptation to the firing system, if necessary. Additive manufacturing, like various forms of 3D-Printing, can be carried out, where one material is chosen for a surface layer and another material is chosen for the core, the bulk material.

In a first embodiment, the raw material for the breech block is manufactured additively from a material. The material consists of a low alloy steel, medium alloy steel or a stainless steel. Medium-alloy and stainless steel reduces the risk of the grains that make up the metal powder oxidizing before the additive manufacturing as well as hip and then provides better toughness and fracture toughness properties. Examples of medium-alloyed and stainless steel are metals alloyed with at least 5% Cr. Chromium prevents the grains from oxidizing as chromium forms chromium oxide on contact with air. For instance of low-alloy NiCrMo carbon steel, i.e. a steel with a lower percentage of alloy elements, with the same or similar chemical composition as adjacent parts (back piece and barrel). By choosing a steel quality with similar properties to other parts of the firing system, good material compatibility can be achieved. It is important to avoid oxides on the particles/grains in the metal powder as oxides create natural pathways for cracks to propagate. Construction direction is also important in additive manufacturing as the structure of the metal is controlled by this factor. It also leads to the material becoming anisotropic, i.e. different properties in different directions. Correspondingly the same as for forging and grain direction.

In a second embodiment, the raw material for the breech block is manufactured additively from two materials, a first material in the surface layer and another material in the core, the bulk material. The material for the surface layer preferably consists of low-alloy NiCrMo carbon steel, i.e. a steel with a lower percentage of alloy elements, with the same or similar chemical composition as adjacent parts (back piece and barrel). By choosing a steel quality with similar properties to other parts of the firing system, good material compatibility can be achieved. The core, the bulk material, can then consist of a different material with different properties adapted to better withstand the recoil forces acting on the breech block.

A number of different methods for additive manufacturing are considered relevant such as
Electron Beam Melting (EBM)
Direct Laser Metal Sintering (DMLS).

With electron beam melting, EBM, the part is manufactured layer by layer in a vacuum chamber and uses an electron beam to melt metal powder fed from a holder/cartridge, and distributed/spread on a platform/coordinate table. The electron beam then heats the metal powder and melts the metal powder to prepare a piece, also called a blank. A relatively high temperature is generated by the electron beam, which melts the metal powder at the focal point of the electron beam. By distributing the material/melting the material based on a CAD model, a piece can be created which has a large degree of flexibility regarding geometric structure. Furthermore, several metal powders can be used for the creation of a piece consisting of several different materials. The piece is built layer upon layer.

By means of Direct Metal Laser Sintering, DMLS, the piece, also called raw material, is manufactured by heating one or more different powder materials and spreading them out in an even layer over a platform/coordinate table with a roller, after which a pulsed laser irradiates selected parts of the powder material, where a cross-section can be created by the powder particles, through the heat generated by the laser, sticking together and forming a piece. The layer thickness is 0.1 mm and powder that does not become a part of a piece can be reused.

By undergoing HIP on the additively manufactured component, pores/inclusions/other defects present in an additively manufactured part will be sealed or closed. The additive manufacturing, 3D printing, is conveniently carried out in a vacuum in a vacuum chamber or in a pressure chamber with an added shielding gas, which means compression during hot isostatic pressing, HIP, is made possible. If additive manufacturing were to take place at atmospheric pressure in air, hot isostatic pressing can result in pores not being closed in the desired way as the air cannot be compressed in the same way as for a part manufactured in a vacuum or in a pressure chamber with added shielding gas.

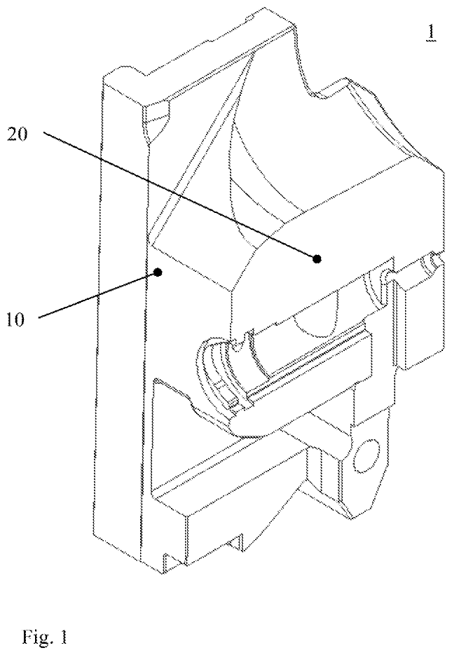

In FIG. 1, a breech block is shown in cross-section where the breech block has a surface material and a bulk material. In a first embodiment, surface material and bulk material are the same material. In a second embodiment, the bulk material and the surface material are of different types, where the bulk material is of preferably stainless powder steel such as a martensitic steel and a surface material is of preferably low alloy carbon steel. The bulk material preferably has material properties that result in high toughness and maintained or slightly lower strength when the stresses are at their highest in the surface. The contact surface between the bulk material and the surface capsule is a diffusion bond that is created by means of hot isostatic pressing of the powder component/raw material. The additively manufactured component, the raw material, is arranged in an oven preferably outfitted with a connection device for the evacuation of air, vacuum pumping, before and/or during the implementation of the manufacturing method in the form of hot isostatic pressing.

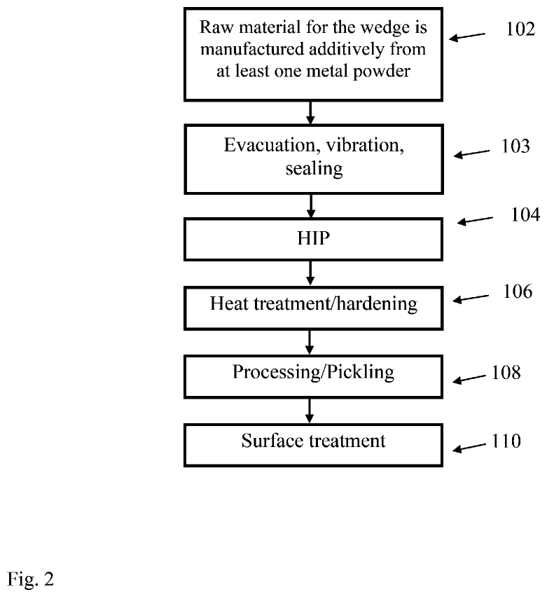

FIG. 2 shows the manufacturing method for breech block with HIP. Initially, a raw material for breech block is manufactured additively from at least one first metal powder in the step Raw material for breech block is manufactured additively from at least one metal powder. In an alternative embodiment, one metal powder is used for the surface coating of the raw material for the breech block and another metal powder is used for the bulk material, the core, of the raw material for the breech block. The raw material for the breech block is manufactured from powder with an additive manufacturing method, for example EBM or DMLS but also other currently available methods, and any possible future additive manufacturing methods can be used to manufacture the raw material for the breech block. In step Evacuation, vibration, closure, the raw material for the breech block can be prepared for the next step, HIP. In the case that the raw material is manufactured in a wholly additive fashion, step can be omitted as the raw material is already prepared for HIP. Hot isostatic pressing is then carried out in step HIP. Meaning that a gas is used to create an isostatic pressure on the raw material by connecting the gas to a connection device on the furnace. Before the gas is arranged for the oven, the oven can be vacuum-pumped or otherwise evacuated of air or of the filling gas/fluid that is present in the oven prior to evacuation, for instance by flushing with a noble gas. The entire raw material is then heated to create a preform, or a HIPPAD body. The HIP temperature is preferably 20% below the melting temperature for the material; for martensitic steel, the HIP temperature during the phase conversion (which is in the order of magnitude of 80% of the material's melting point). Once the hot isostatic pressing is completed, the body can undergo heat treatment/hardening, which means that the now merged body is heated. Following heat treatment, the material is suitable for processing, e.g. processing by means of cutting in the step Processing, where cutting processing such as turning or milling or grinding. Where applicable, a surface treatment such as phosphating or manganese phosphating is also carried out for purposes of rust protection.

The invention is not limited to the embodiments specifically shown, but can be varied in different ways within the framework of the claims.

For instance, it is clear that the choice of material, choice of geometric forms, the elements and details included in the breech block or the components for the firing system and the particulars are adapted to the weapons system(s), platforms and other construction-related properties that are applicable at this time.

Furthermore, all types of breech blocks and bolts for small caliber, medium caliber and large caliber are included.

1. A method for the production of a breech block for a cannon, the method comprises manufacturing a raw material for a breech block additively from two different metal powders, a surface material and a bulk material, once a raw material for a breech block has been manufactured, and exposing the raw material for the production of a breech block to high pressure and heat, also called Hot Isostatic Pressing, HIP, for pressing and sintering the metal powders included in the raw material.

2. The method according to claim 1, characterized in that additive manufacture comprises the metal powder being melted in a vacuum chamber by an electron beam.

3. The method according to claim 1, characterized in that additive manufacture comprises the metal powder being distributed over a surface and melted by a laser beam.

4. The method according to claim 1, further comprises a heat treatment, following hot isostatic pressing.

5. The method according to claim 4, characterized in that post-treatment further includes mechanical processing of the breech block, following hot isostatic pressing and heat treatment.

6. The method according to claim 1, characterized in that the surface material preferably consists of low-alloy NiCrMo steel.

7. The method according to claim 1, characterized in that the bulk material preferably consists of stainless steel or tool steel.

8. A Breech block with high tolerance adapted to cooperate with other metal components included in the cannon manufactured according to claim 1.

9. A Cannon arranged with a breech block according to claim 8.
